(19) United States
(12) Patent Application Publication
(10) Pub. No.: US 2017/0372398 A1
(43) Pub. Date: Dec. 28, 2017

(54) VECTOR REPRESENTATION OF DESCRIPTIONS AND QUERIES

(71) Applicant: eBay Inc., San Jose, CA (US)

(72) Inventors: Selcuk Kopru, Santa Clara, CA (US); Mingkuan Liu, San Jose, CA (US); Hassan Sawaf, Los Gatos, CA (US)

(21) Appl. No.: 15/192,323

(22) Filed: Jun. 24, 2016

(51) Int. Cl. G06Q 30/06; G06F 17/30; G06N 99/00

(52) U.S. Cl. CPC G06Q 30/0627; G06N 99/005; G06F 17/30477; G06F 17/30554; G06F 17/3056

(57) ABSTRACT

In various example embodiments, a system and method for vector representation of descriptions and queries are presented. A query that includes one or more search terms is received. A vector that corresponds to the query is generated. An item vector that corresponds to a description of at least one published item listing is accessed. A distance in a common vector space is measured between the vector that corresponds to the query and the item vector. A match is determined based on the distance.

### TECHNICAL FIELD

Embodiments of the present disclosure relate generally to analyzing data and projecting data into a common vector space. More particularly, but not by way of limitation, the embodiments relate generally to vector representation of descriptions and queries.

### BACKGROUND

Conventionally, a keyword search of an item listing includes matching the keyword to a textual description of the item listing. For example, conventional practices of a query search include parsing the query to identify keywords. Once the keywords are identified, they are matched to words or phrases in the textual descriptions of one or more result listings.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating components of a vector system, according to some example embodiments.

FIG. 3 is a flowchart illustrating operations of a vector system in performing a method of training neural networks and generating vectors, according to some example embodiments.

FIG. 4-6 are flowcharts illustrating operations of a vector system in performing a method of matching one or more search terms to a product description, according to some example embodiments.

FIG. 7 is a block diagrams that depicts an example user interface of a search query and corresponding search results, according to some example embodiments.

FIG. 8 is a block diagram that depicts an example user interface of an item listing, according to some example embodiments.

FIG. 9 is a block diagram that depicts an example user interface of a search query and corresponding search results, according to some example embodiments.

FIG. 10 is a block diagram that depicts an example user interface of a search query and corresponding search results, according to some example embodiments.

FIG. 11 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various example embodiments of the subject matter discussed herein. It will be evident, however, to those skilled in the art, that embodiments of the subject matter may be practiced without these specific details.

In various example embodiments, a system matches a search query received from a user device to a description of at least one published item listing (e.g., description of product). The system performs the match based on projections of the search query as well as projections of all published item listings in a common vector space. In other words, vectors of the published item listings is accessed by the system. The published item listings correspond to listings of all items that are available for sale as indicated in an item inventory. Further, the system generates a vector for the search query. Once generated, the system measures distances between the vector for the search query in the common vector space and the vectors of the all the published item listings in order to determine the match. This approach of matching a query to a product description has certain advantages over a conventional keyword matching.

For example, in some instances, if the user is searching for a product that is listed by its formal name, but the user is unable to recall the formal name of the product, the user may enter in one or more search terms that describe the product without using any formal identifiers for the product. As a result, the search query may include terms that are different than the product description. However, since the matching is performed using vectors in the common vector space, the system is still able to detect the match. Accordingly, the system presents to the user a search result of the matching product listing.

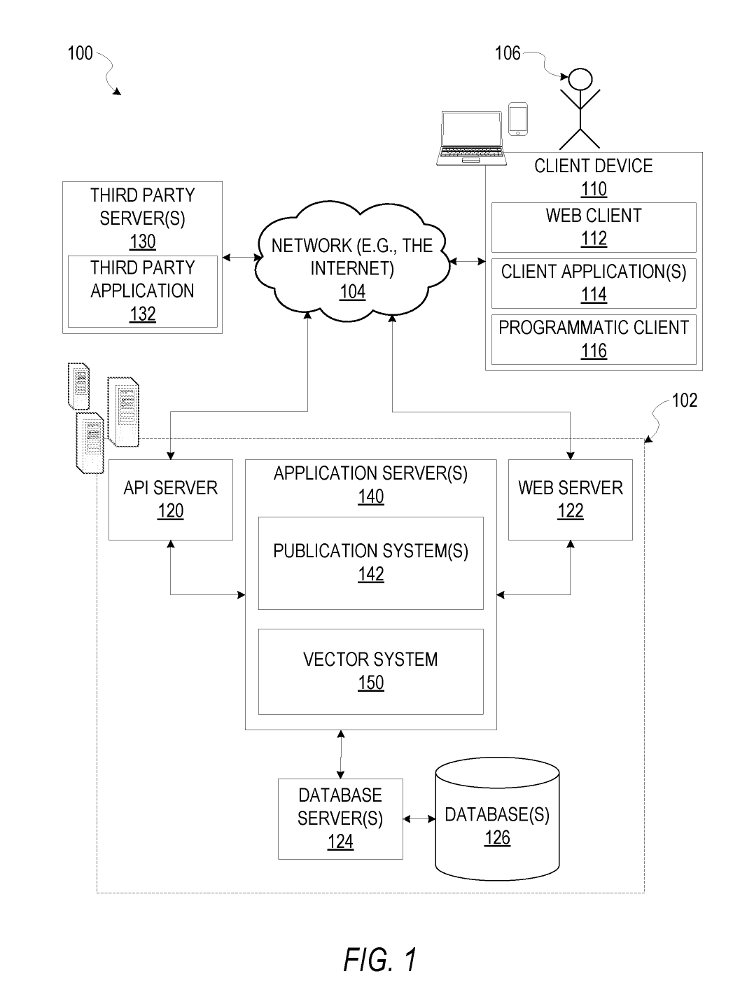

With reference to FIG. 1, an example embodiment of a high-level client-server-based network architecture 100 is shown. A networked system 102, in the example forms of a network-based publication or payment system, provides server-side functionality via a network 104 (e.g., the Internet or wide area network (WAN)) to one or more client devices 110. FIG. 1 illustrates, for example, a web client 112 (e.g., a web browser), a client application 114, and a programmatic client 116 executing on client device 110.

The client device 110 may comprise, but is not limited to, a mobile phone, desktop computer, portable digital assistants (PDAs), smart phones, tablets, laptops, multi-processor systems, microprocessor-based or programmable consumer electronics, or any other communication device that a user may utilize to access the networked system 102. In some embodiments, the client device 110 comprises a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based publication system that responds to requests for product listings, publishes publications comprising item listings of products available on the network-based publication system, and manages payments for these marketplace transactions. For example, one or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client devices 110 include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but interacts with the network architecture 100 via the client device 110 or other means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

An application program interface (API) server 120 and a web server 122 are coupled to, and provide programmatic and web interfaces respectively to, one or more application servers 140. The application servers 140 hosts one or more publication systems 142, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, or publication functions that are supported by the relevant applications of the networked system 102.

The publication systems 142 provide a number of publication functions and services to users 106 that access the networked system 102. While the publication system 142 is shown in FIG. 1 to both form part of the networked system 102, it will be appreciated that, in alternative embodiments, the publication system 142 may form part of a service that is separate and distinct from the networked system 102.

The vector system 150 provides functionality operable to perform projection of data from various sources into a common vector space. For example, the vector system 150 may access product listing data from the databases 126, the third party servers 130, the publication system 142, and other sources. In response, the vector system 150 performs an analysis on the product listing data that results in a projection of the product listing data into the common vector space. The vector system 150 may further receive data for user queries from the client device 110. Moreover, the vector system 150 performs an analysis on the data for the user queries that results in a projection of the user queries into the common vector space. In some example embodiments, the vector system 150 communicates with the publication systems 142 (e.g., access item listing data). In an alternative embodiment, the vector system 150 may be a part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, and vector system 150 could also be implemented as standalone software programs, which do not necessarily have networking capabilities.

The web client 112 accesses the various publication systems 142 via the web interface supported by the web server 122. Similarly, the programmatic client 116 accesses the various services and functions provided by the publication systems 142 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

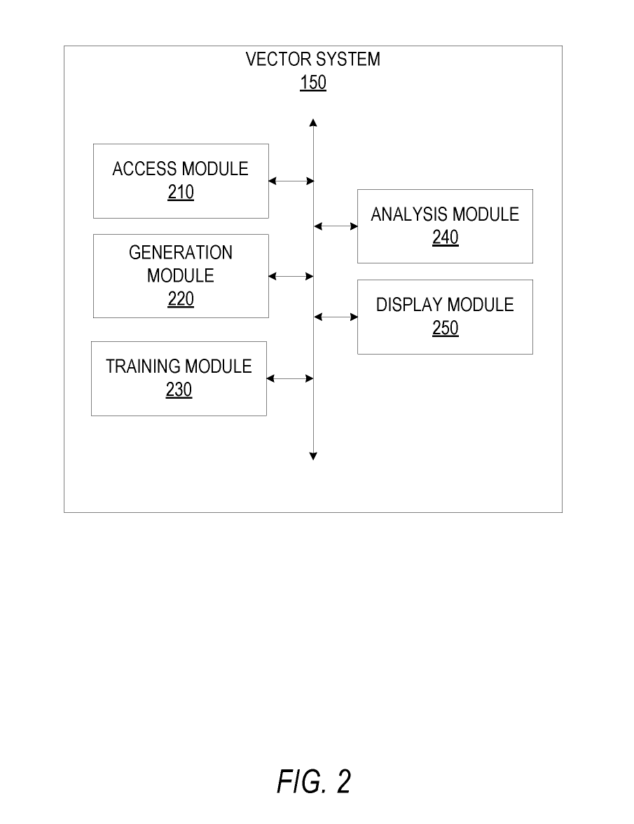

FIG. 2 is a block diagram illustrating components of the vector system 150, according to some example embodiments. The vector system 150 is shown as including an access module 210, a generation module 220, a training module 230, an analysis module 240, and a display module 250, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the access module 210 is configured to access or receive data that is eventually projected into a common vector space. As further explained below, the common vector space is an area where projections of the data are embodied as vectors. Moreover, distances can be measured between the vectors and the distances between the vectors indicate how closely related the vectors are (e.g., the data represented by the vectors). In various example embodiments, the data includes search queries, and the access module 210 is configured to receive queries that include one or more search terms. The query is received by the access module 210 from a device (e.g., client device 110) that is operated by a user. In other words, the user operating the device transmits the query to the access module 210. In various example embodiments, the data includes descriptions of products, and the access module 210 is configured to receive a description of a product from a product listing database (e.g., database 126).

In various example embodiments, the generation module 220 is configured to generate vectors that correspond to the data received by the access module 210. For instance, the generation module 220 generates a vector that corresponds to the query received by the access module 210. Also, the generation module 220 generates a vector that corresponds to the description of the product received by the access module 210. Moreover, the generated vectors are projected into the common vector space. Effectively, the generation module 220 generates projections of the data received by the access module 210 into the common vector space. As a result, the common vector space includes one or more vectors that correspond to descriptions of one or more products. Similarly, the common vector space includes a vector that corresponds to a description of a query. In some instances, all of the items in an item inventory are projected in the common vector space.

In various example embodiments, the analysis module 240 is configured to analyze certain relationships among the data that is utilized by the vector system 150. For example, the analysis module 240 is configured to identify a distance between two vectors in the common vector space. In various example embodiments, the distance between the two vectors indicates how closely related the data being projected in the common vector space are. In further example embodiments, the analysis module 240 identifies product listings or item listings that are listed by the publication system 142.

In various example embodiments, the analysis module 240 analyzes the data used by the vector system 150. For instance, the analysis module 240 determines a match from among the data received at the access module 210. For example, the analysis module 240 determines a match between the received query and the received product descriptions.

In various example embodiments, the display module 250 causes display of information on a client device (e.g., client device 110). For example, the display module 250 causes display the product listings or item listings or products that are listed by the publication system 142. Further, the display module 250 is configured to cause display of the information as a result of the analysis performed by the analysis module 240.

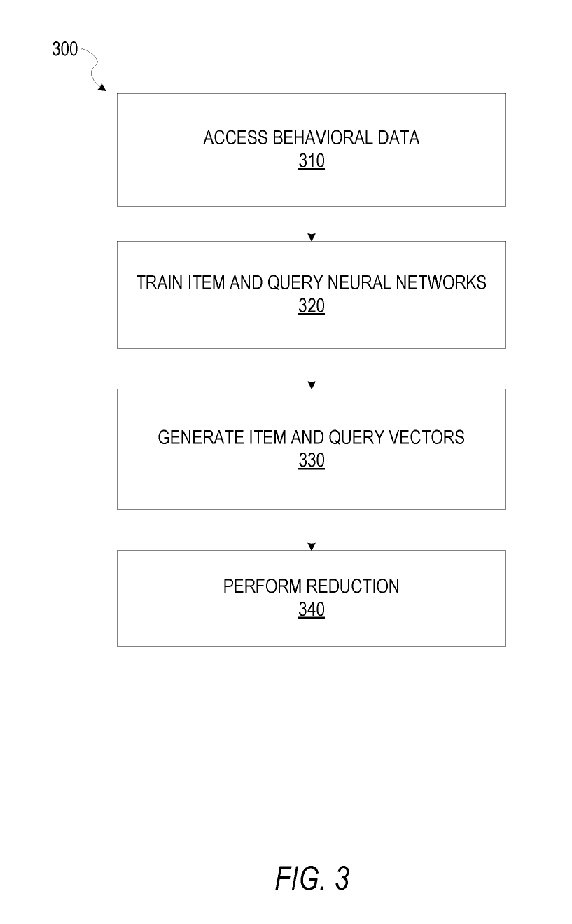

FIG. 3 is a flowchart illustrating operations of the vector system 150 in performing a method 300 of training neural networks and generating vectors, according to some example embodiments. Operations in the method 300 may be performed by the vector system 150, using modules described above with respect to FIG. 2.

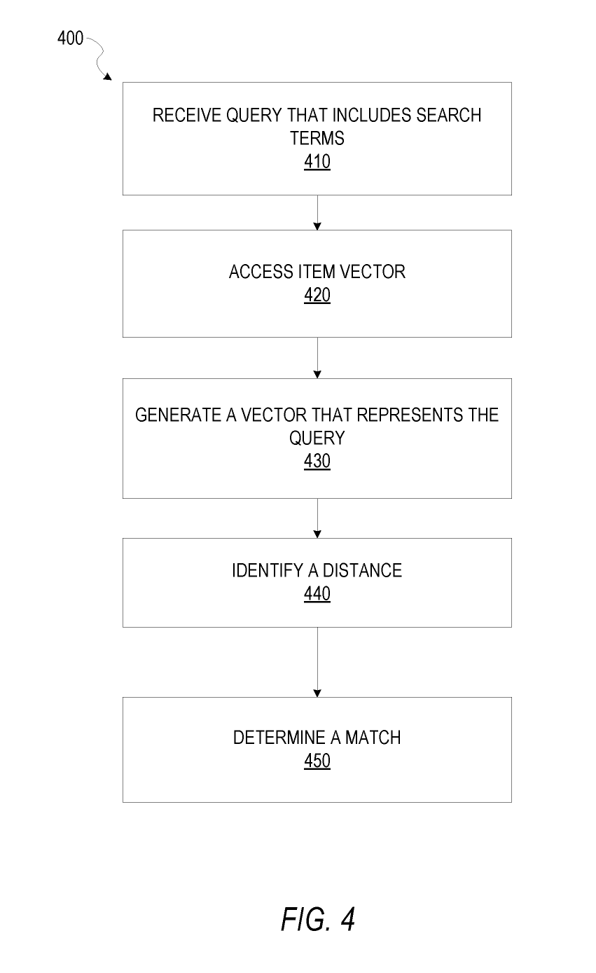

FIG. 4-6 are flowcharts illustrating operations of the vector system 150 in performing a method 400 of matching one or more search terms to a product description, according to some example embodiments. Operations in the method 400 may be performed by the vector system 150, using modules described above with respect to FIG. 2.

As shown in FIG. 3, the method 300 includes operations 310, 320, 330, and 340. At operation 310, the training module 230 accesses behavioral data from a database (e.g., database 126). The behavior data indicates query item pairs. A query item pair identifies both an item and a query. In some instances, the item is purchased as a result of the query. Also, the item may be an item that is published in an item listing by a network publication system. Accordingly, in some instances, the query item pair identifies the item using any information from the published item listing (e.g., description, titles, images, aspects, and the like). Further, the query, in some instances, is submitted by a user of the network publication system and results in retrieval of the published item listing. Moreover, the operations performed by the training module 230 in operation 310 may be performed offline (e.g., without communicating with the client device over the network 104).

At operation 320, the training module 230 trains neural networks using the accessed behavioral data. In some instances, a first neural network that corresponds to queries submitted by users of the network publication system and a second neural network that corresponds to items published by the network publication system are being trained by the training module 230. Each neural network is trained using the accessed behavior data. Moreover, a goal of the training is to calibrate the neural networks such that they are in accordance with the behavior data (e.g., the query item pairs). In some instances, the neural networks are used to generate vectors, as further explained below. Therefore, the neural networks are trained such that the vectors generated by the neural networks will be in accordance with the behavior data. In other words, an objective function in the training can be the squared distance between two generated vectors for the query-item pairs with the aim that the query and item vectors will be very close to each other if they are semantically similar. Moreover, the operations performed by the training module 230 in operation 320 may be performed offline (e.g., without communicating with the client device over the network 104).

At operation 330, the generation module 220 generates vectors based on the trained neural networks. In particular, the generation module 220 generates a query vector using the first neural network. In some instances, the query vector is not generated until later, as shown in FIG. 4. Also, the generation module 220 generates an item vector using the second neural network. In various example embodiments, the vectors being generated are semantic vectors. Also, as stated earlier, each of the neural networks is trained using the accessed behavior data. In some instances, the generation module 220 generates item vectors for all item listings published by the network publication system. In other words, for each item listing published by the network publication system, the generation module 220 generates a respective item vector. Once generated, the item vectors are stored in a database (e.g., database 126) by the access module 210. In some instances, the item vectors that are generated by the generation module 220 form an index of vectors. Further, the generation module 220 generates the query vector for any queries that are received at the access module 210, as further explained below. Moreover, the vector generation of the item vectors may be performed by the generation module 220 offline (e.g., without communicating with the client device over the network 104).

Moreover, in some instances, the generated vectors each includes at least two components. The two components each indicates a value that is used to project the query into a common vector space. In various example embodiments, the generation module 220 generates the vectors based on a machine-learning model (e.g., neural networks), and the machine-learning model converts words from the query and the description into a common vector space. In other words, the machine-learning model is a function that projects alphanumeric characters into the common vector space, as further explained below. As a result, the query vector is a projection of the query into the common vector space. Likewise, the item vectors are projections of all the item listings into the common vector space.

In various example embodiments, the access module 210 accesses a description of the product from an item listing of an item that corresponds to the description of the product. In other words, the description of the product is found from one published listings of items that correspond to the description of the product. In further example embodiments, the access module 210 receives the description of the product from a device of a seller. In further example embodiments, the description of the product is stored in a database that is in communication with the publication system 142, and therefore the access module 210 accesses the description of the product from the product listing database (e.g., database 126). In further example embodiments, the analysis module 240 identifies other descriptions of the product from a product listing database (e.g., database 126). The other descriptions of the product, in some instances, is submitted by other sellers of the same product or same item. For example, if the product is a smart phone cover, a first description is received from a first seller of the smart phone cover and another description is received from a second seller of the same smart phone cover. In various example embodiments, the other descriptions are retrieved from the database by the analysis module 240. In further example embodiments, the other descriptions are received from devices operated by other sellers. Each of the accessed descriptions may be used by the generation module 220 to generate a respective item vector.

At operation 340, the analysis module 240 performs a reduction on the index of vectors. In other words, the analysis module 240 filters the generated item vectors according to various schemes. For example, the analysis module 240 identifies a subset of item vectors that correspond to item listings of items in a certain category (e.g., sports, electronics, and the like). As another example, the analysis module 240 identifies a subset of item vectors that are within a certain layer. Further, the layers may be predetermined using various algorithms or techniques. Once identified, the subset of item vectors are used by the analysis module 240 for comparison. This allows for more efficient comparison of vectors because rather than comparing a query vector with all of the generated item vectors, only a subset of the generated item vectors are compared with the query vector.

In various example embodiments, the analysis module 240 performs a search using the generated item vectors. In some instances, the analysis module 240 conducts the search by comparing the generated item vectors with the generated query vector. In other words, the search involves comparing the vectors that are generated by the generation module 220 at the operation 330 in order to find a match. The generated query vector is compared with each of the generated item vectors. In some instances, the squared distance between each of the vectors is measured by the analysis module 240, as further explained below. More details on the comparisons performed by the analysis module 240 are shown in FIG. 4. Further, the operations 310, 320, 330, and 340 may be performed prior to the operation 410 of FIG. 4.

As shown in FIG. 4, the method 400 includes operations 410, 420, 430, 440, and 450. At operation 410, the access module 210 receives a query that includes one or more search terms. Moreover, the query is transmitted from a device (e.g., client device 110) that is operated by a user. In some instances, the user is searching for an item. Therefore, the query that is transmitted is a sentence that is used by the user to describe the item being searched. Effectively, each of the one or more search terms is a word from the sentence used to describe the item being searched. As a result, a search term from the query may describe an attribute of the item (e.g., size, color, type, and the like). The search term from the query may also describe a unique identifier for the item (e.g., item model number, an SKU number, and the like).

At operation 420, the access module 210 accesses an item vector from a database (e.g., database 126). Moreover, the item vector corresponds to a description of a product. In various example embodiments, the description of the product corresponds to an item or a group of items. Further, the item or group of items are listed by the publication system 142 as being available for sale. Accordingly, the item vector corresponds to a description of at least one published item listing. For example, the description of the product may indicate a particular smart phone model, and the publication system 142 may have five published item listings of items that correspond to the particular smart phone model. As another example, the description of the product is a particular car model, and the publication system 142 may have three published item listings of items that correspond to the particular car model. Also, the item vector is previously generated and stored in the database, as described above with respect to the operation 320. Further, the item vector, in various example embodiments, belongs in the reduced or filtered subset of item vectors identified in the operation 340 of FIG. 3.

In some instances, each of the one or more search terms does not match with any words in the description of the at least one item listing (e.g., the description of the product). This situation may occur, for example, if the user is searching for a product that is listed by its formal name, but the user is unable to recall the formal name of the product, the user may enter in one or more search terms that describe the product without using any formal identifiers for the product. Likewise, if a seller is listing a product but is unable to recall to the formal name of the product, the seller may describe the product without using any formal identifiers for the product. Users that describe the product using formal identifiers for the product can still find the seller's listing.

At operation 430, the generation module 220 generates a vector that corresponds to the query (e.g., query vector). Moreover, in some instances, the generated vector includes at least two components. The two components each indicates a value that is used to project the query into a common vector space. In various example embodiments, the generation module 220 generates the vectors based on a machine-learning model, and the machine-learning model converts words from the query and the description into a common vector space. In other words, the machine-learning model is a function that projects alphanumeric characters into the common vector space, as further explained below. In various example, the machine-learning model corresponds to the neural networks described above with respect to FIG. 3. As a result, the vector that corresponds to the query is a projection of the query into the common vector space.

At operation 440, the analysis module 240 identifies a distance in the common vector space between the vector that corresponds to the query and the item vector that corresponds to the description. In various example embodiments, the analysis module 240 measures the distance between the two vectors by using the values for each of the vectors. The distance, in some instances, is measured between end points of each of the two vectors in the common vector space. In further instances, the distance is the squared distance between each of the two vectors in the common vector space.

At operation 450, the analysis module 240 determines a match between the one or more search terms and the description of the at least one item listing based on the distance. In various example embodiments, the analysis module 240 determines that the distance between the vector that corresponds to the query and the item vector that corresponds to the description is within a predetermined distance. Once a match is determined, the generation module 220 creates an association between the one or more search terms included in the query and the description of the at least one item listing. Moreover, the created association may be used to modify or update the machine-learning model used to convert words into the common vector space.

In various example embodiments, the generation module 220 creates a database entry that links the one or more search terms to the description of the product. Further the database entry may be stored in a database, which may be used to modify or update the machine-learning model used to convert words into the common vector space.

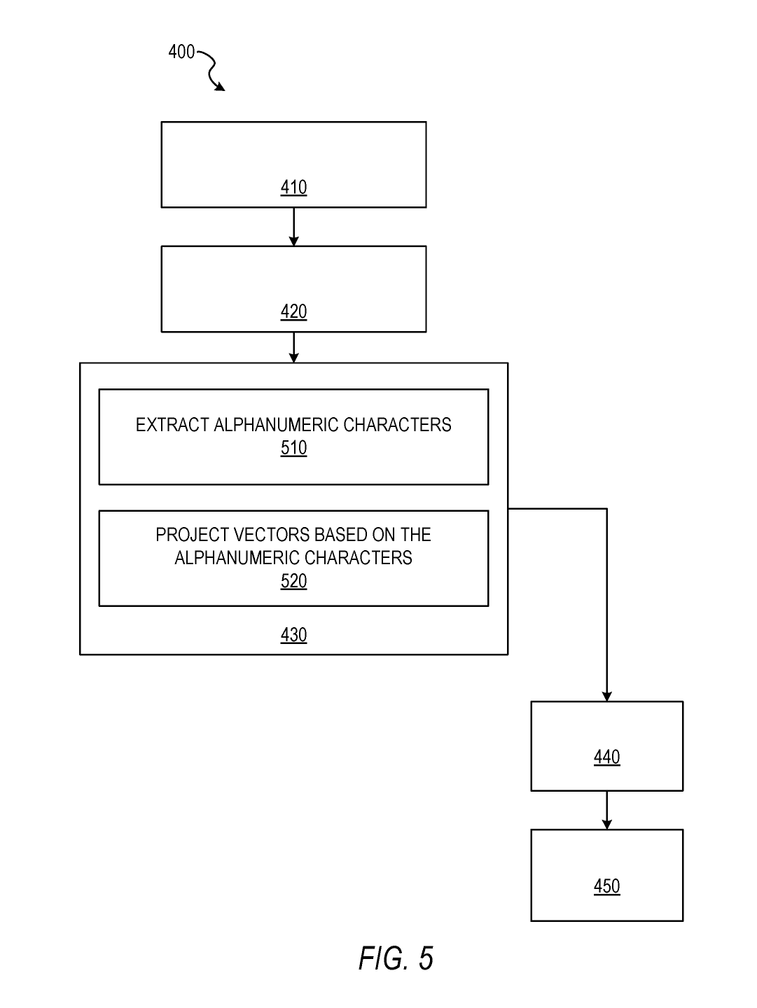

As shown in FIG. 5, the method 400 includes one or more of operations 510, and 520. Operations 510, and 520 may be performed as part (e.g., a subroutine, or a portion) of operation 430.

At operation 510, the analysis module 240 extracts alphanumeric characters from the one or more search terms and the description of the product. In other words, the analysis module 240 parses the one or more search terms in order to obtain the alphanumeric characters from the one or more search terms. Likewise, the analysis module 240 parses the description in order to obtain the alphanumeric characters from the description of the product.

At operation 520, the analysis module 240 projects vectors based on the alphanumeric characters. In further embodiments, the analysis module 240 projects the vectors in the common vector space based on the values generated at the operation 520.

In various example embodiments, the analysis module 240 generates values in the common vector space using the extracted alphanumeric characters. In various example embodiments, the analysis module 240 utilizes the machine-learning model (e.g., neural network) in order to generate the values in the common vector space from the extracted alphanumeric characters. As stated above, the machine-learning model is used to project the one or more search terms and the description of the product into the common vector space. In some instances, the machine-learning model receives alphanumeric characters as input and outputs values in the common vector space as output. As a result, using the machine-learning model, the analysis module 240 generates values in the common vector space for the one or more search terms. The analysis module 240 further generates values in the common vector space for the description of the product.

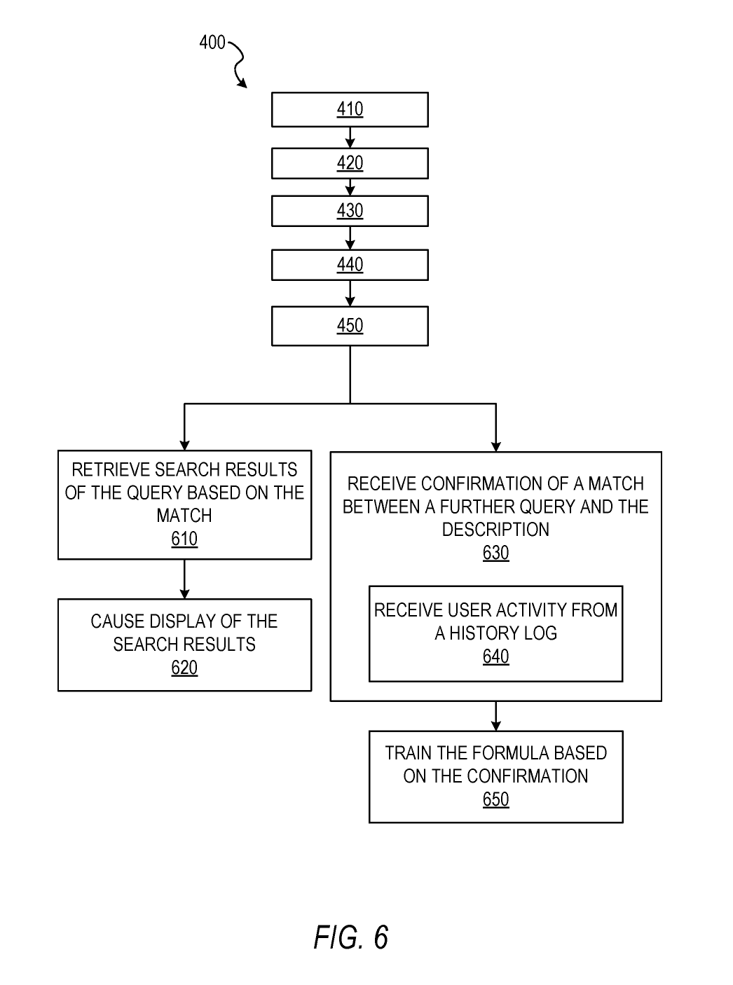

As shown in FIG. 6, the method 400 includes one or more of operations 610, 620, 630, 640, and 650. Each of the operations 610, 620, 630, 640, and 650 may be performed after the operation 450. Further, the operation 640 may be performed as part of the operation 630 (e.g., a subroutine).

At operation 610, the analysis module 240 retrieves search results of the query based on the determined match. The analysis module 240, in various embodiments, identifies the item listing of the item that corresponds to the product description. As stated earlier, the description of the product is retrieved or accessed from the item listing of the item that corresponds to the product description. Since it is determined that the description of the product matches with the query, the search results of the query include the item listing of the item that corresponds to the product description.

In further embodiments, the analysis module 240 identifies one or more further items that fit the description of the at least one item listing. Moreover, the analysis module 240 searches for published item listings of the one or more further items that fit the description of the at least one item listing. As stated earlier, the description of the product corresponds to an item or a group of items. Accordingly, there may be one or more further item listings published by the publication system 142 that fit the description of the at least one item listing. Further, each of the identified one or more item listings is identified by the analysis module 240 as being part of the retrieved search results.

At operation 620, the display module 250 module causes display of search results of the query. The display module 250, in various example embodiments, transmits data that causes display of the search results of the query. The data may be transmitted by the display module 250 to a client device (e.g., client device 110). The search results of the query may include the item listing of the item that corresponds to the product description. The search results of the query may also include the one or more further item listings published by the publication system 142 that fit the description of the product.

At operation 630, the access module 210 receives confirmation of a match between a further query and the description of the at least one item listing. The confirmation of the match, in various embodiments, indicates that the further query is associated with the description of the at least one item listing. In other words, the confirmation of the match indicates that the further query is being used to search for one or more items that fit the description of the at least one item listing, as further explained below.

At operation 640, the access module 210 receives user activity that indicates purchase of an item described by the description of the product after viewing search results of the further query. The user activity is received, in some instances, from a history log that is stored in a database (e.g., database 126). Moreover, the user activity is stored in the database upon detection of the activity by the user with the publication system 142. For example, the search results of the further query may indicate the product described by the description of the product. Moreover, the user may decide to purchase the product after viewing the search results of the further query. Each of these actions may be stored in the database as part of the history log. In some instances, the user activity is received from client devices of users of the network publication system 142.

At operation 650, the analysis module 240 trains the machine-learning model based on the received confirmation of the match. Effectively, the words from both the further query and the description of the product are used by the analysis module 240 in training the machine-learning model. In particular, the machine-learning model is trained such that vectors for the further query and the description of the product will be close in distance (e.g., when using the machine-learning model for conversion).

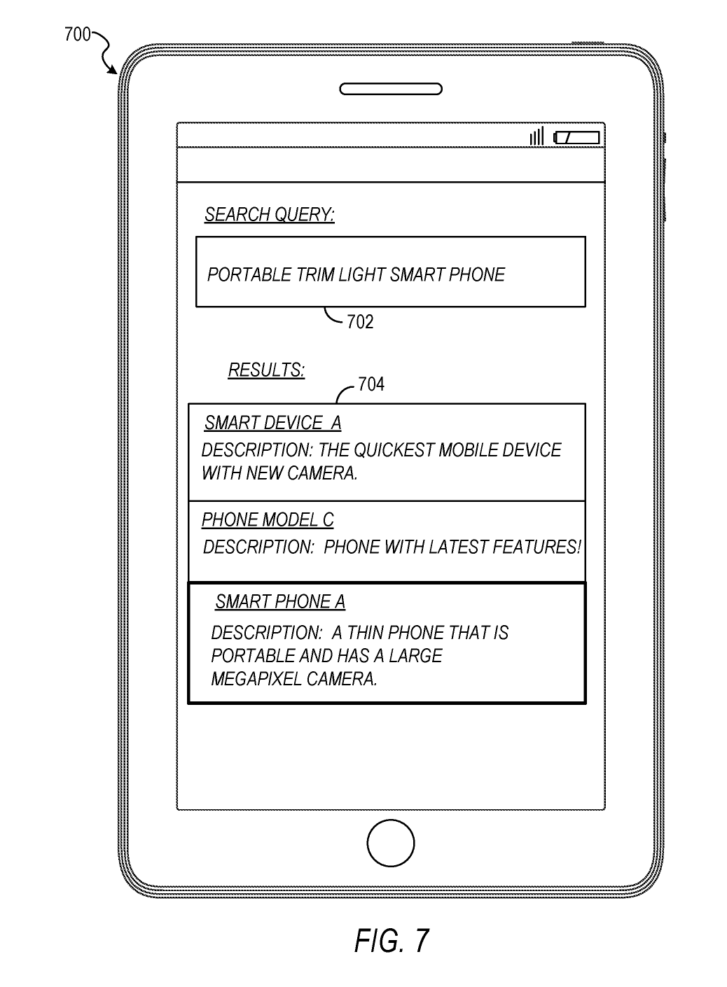

FIG. 7 is a block diagram that depicts an example user interface 700 of a search query and corresponding search results, according to some example embodiments. The example user interface 700, in some instances, is displayed on a client device. As shown in FIG. 7, the user interface 700 includes a search query 702 and the corresponding search results 704. In various example embodiments, the search results 704 are identified or retrieved based on a determined match (e.g., operation 610 of FIG. 6) between the search query 702 and a product description. Moreover, the match is determined based on distances between vectors in a common vector space. Further, the search results are retrieved based on the determined match. As a result, the search results 704 correspond to published item listings that fit the product description, in some example embodiments.

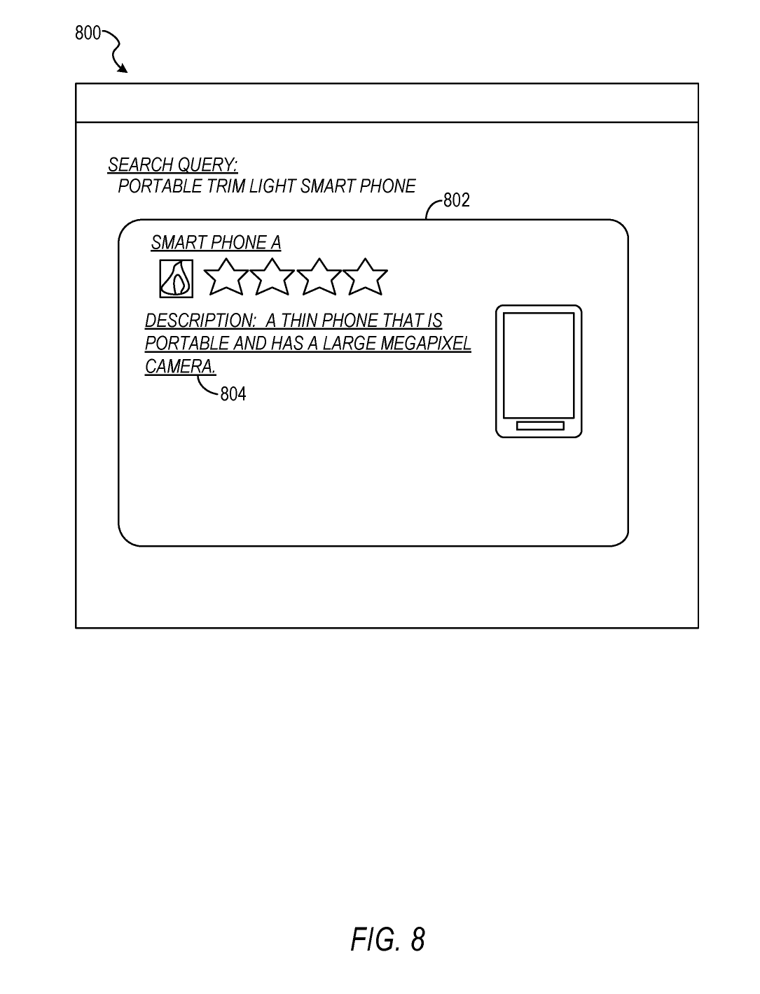

FIG. 8 is a block diagram that depicts an example user interface 800 of an item listing, according to some example embodiments. The example user interface 800, in some instances, is displayed on a client device after selection of one of the search results 704 depicted in FIG. 7. As shown in FIG. 8, the user interface 800 includes a published item listing 802, and an item description 804. The item description 804 is determined to fit the product description that matches with the search query 702 of FIG. 7. In some instances, the item description 804 is identical to the product description that matches with the search query 702. Alternatively, the item description 804 is similar to the product description that matches the search query 702.

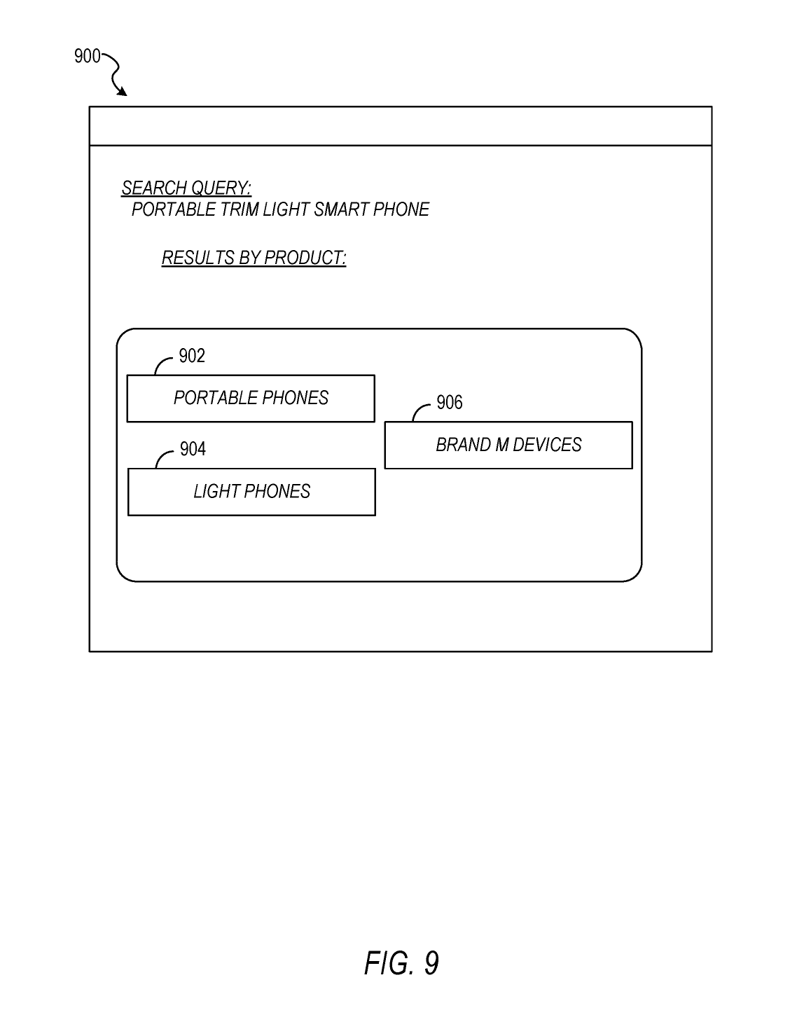

FIG. 9 is a block diagram that depicts an example user interface 900 of a search query and corresponding search results, according to some example embodiments. The example user interface 900, in some instances, is displayed on a client device. As shown in FIG. 9, the user interface 900 includes a first product description 902, a second product description 904, and a third product description 906. Each of the product descriptions may be projected into a common vector space as a vector in the common vector space. Moreover, the distances between the vectors in the common vector space indicates a closeness in relationship between the product descriptions. Further, each of the product descriptions may be identified or retrieved based on a match with the search query. Further, the match is determined based on distances between the vectors in the common vector space. Each of the product descriptions 902, 904, 906 depicted in FIG. 9 can be selected to trigger or cause display of published item listings that fit the respective product description.

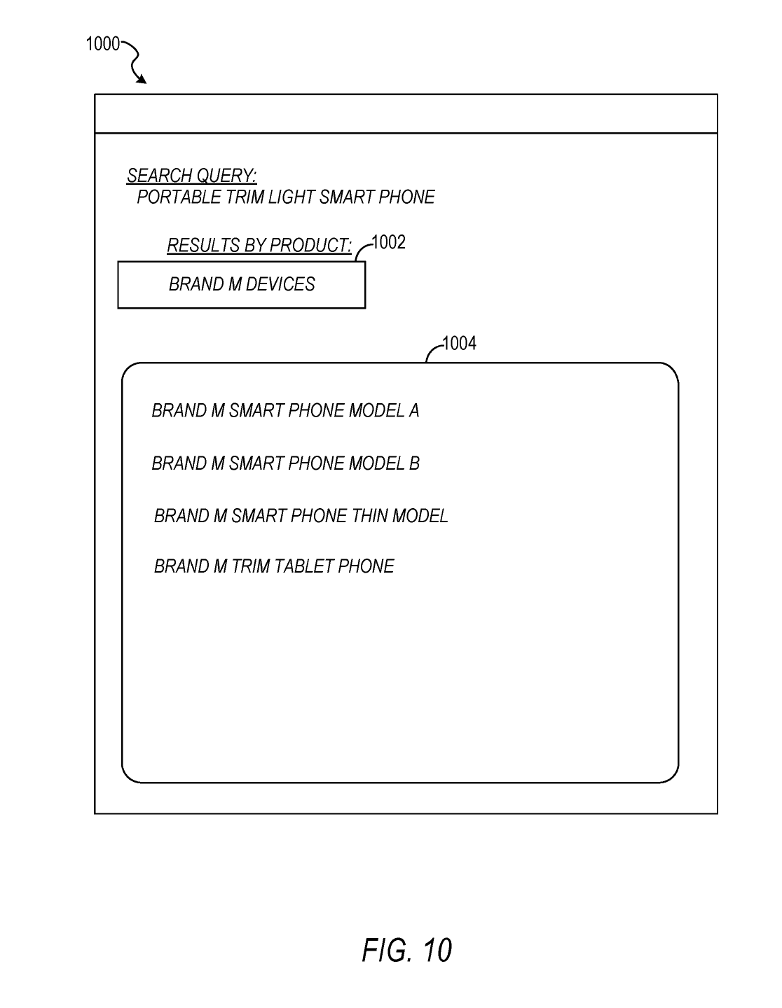

FIG. 10 is a block diagram that depicts an example user interface 1000 of a search query and corresponding search results, according to some example embodiments. The example user interface 1000, in some instances, is displayed on a client device. Further, the example user interface 1000 may be displayed after selection of the product description 906 depicted in FIG. 9. Moreover, the example user interface 1000 includes a search results section 1004 that includes descriptions from published item listings that fit the description of the product 1002. Each of the descriptions shown in the section 1004 can be selected to trigger or cause display of a corresponding published item listing.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Example Machine Architecture and Machine-Readable Medium

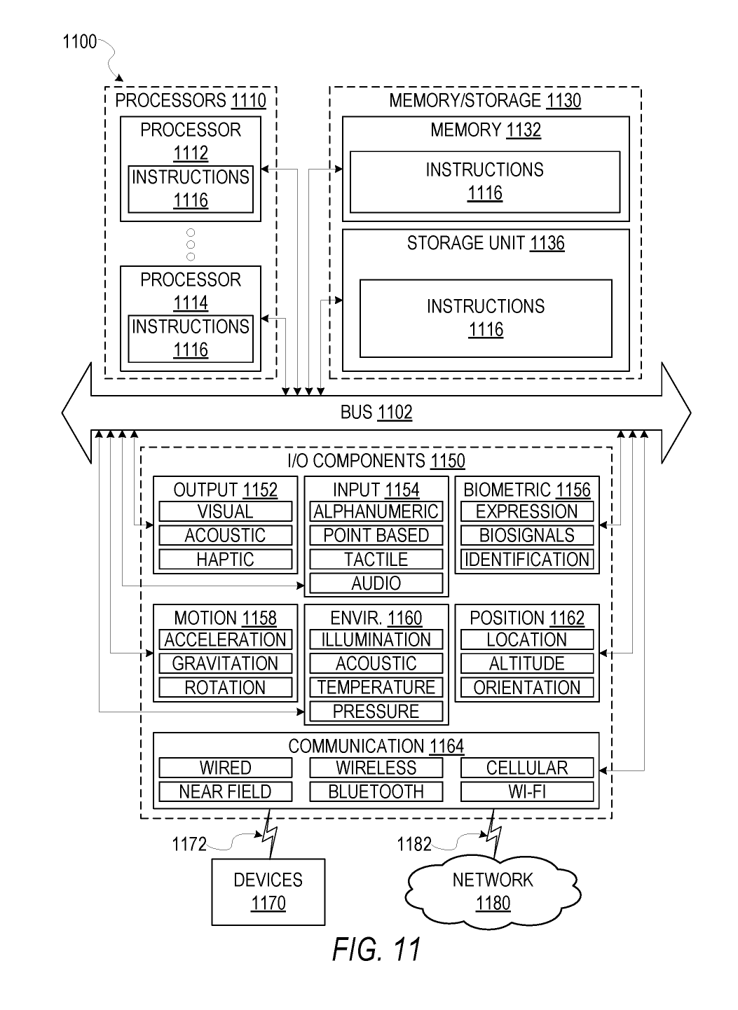

FIG. 11 is a block diagram illustrating components of a machine 1100, according to some example embodiments, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example the instructions may cause the machine to execute the flow diagrams of FIGS. 3-5. Additionally, or alternatively, the instructions may implement the modules of FIG. 2, and so forth. The instructions transform the general, non-programmed machine into a particular machine specially configured to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a smart phone, a mobile device, a wearable device (e.g., a smart watch), other smart devices, a web appliance, a network router, a network switch, a network bridge, or any machine capable of executing the instructions 1116, sequentially or otherwise, that specify actions to be taken by machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1010, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1112 and processor 1114 that may execute instructions 1116. The term “processor” is intended to include multi-core processor that may comprise two or more independent processors (sometimes referred to as “cores”) that may execute instructions contemporaneously. Although FIG. 11 shows multiple processors, the machine 1100 may include a single processor with a single core, a single processor with multiple cores (e.g., a multi-core process), multiple processors with a single core, multiple processors with multiples cores, or any combination thereof

The memory/storage 1130 may include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 may also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of processors 1110 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine 1100 (e.g., processors 1110), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162 among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1162 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via coupling 1182 and coupling 1172 respectively. For example, the communication components 1164 may include a network interface component or other suitable device to interface with the network 1180. In further examples, communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a Universal Serial Bus (USB)).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1180 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or other type of cellular or wireless coupling. In this example, the coupling 1182 may implement any of a variety of types of data transfer technology, such as Single Carrier Radio Transmission Technology (1× RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to devices 1170. The term “transmission medium” shall be taken to include any intangible medium that is capable of storing, encoding, or carrying instructions 1116 for execution by the machine 1100, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving a query that includes one or more search terms, the query being transmitted from a device operated by a user that is searching for an item;
accessing an item vector that corresponds to a description of at least one published item listing;
generating, using one or more processors, a vector that corresponds to the query, the generating being based on a machine-learning model that projects the one or more search terms into a common vector space;
identifying a distance in the common vector space between the vector that corresponds to the query and the item_vector that corresponds to the description; and
determining a match between the query and the description of the at least one item listing based on the distance.

2. The method of claim 1, further comprising:
generating the item vector that corresponds to the description of the at least one published item listing, the generating being based on the machine-learning model; and
storing the item vector in a database, wherein the accessing the item vector includes accessing the item vector from the database.

3. The method of claim 1, further comprising determining that the distance between the vector that corresponds to the query and the item vector is within a predetermined distance; and wherein the determining the match is based on the determining that the distance is within the predetermined distance.

4. The method of claim 1, wherein each of the one or more search terms does not match with any words in the description of the at least one item listing.

5. The method of claim 1, further comprising:
receiving confirmation of a match between a further query and the description of the at least one item listing, the further query including one or more further search terms; and
training the machine-learning model based on the received confirmation of the match between the one or more further search terms and the description of the at least one item listing.

6. The method of claim 5, wherein the receiving the confirmation includes receiving, from a history log database, user activity that indicates a purchase of an item described by the description of the at least one item listing after viewing search results of the further query.

7. The method of claim 1, wherein the generating includes:
extracting alphanumeric characters from the one or more search terms; and
projecting the vector that corresponds to the query in the common vector space based on the alphanumeric characters.

8. The method of claim 1, further comprising:
retrieving search results of the query based on the determined match; and
causing display of the search results of the query, the search results including an item listing of an item that fits the description of the at least one item listing.

9. The method of claim 8, wherein:
the retrieving the search results of the query includes identifying one or more further item listings that fit the description of the at least one item listing; and
the causing display of the search results of the query includes causing display of the further item listings that fit the description of the at least one item listing.

10. The method of claim 1, wherein the common vector space includes further vectors that correspond to descriptions of further products.

11. A system comprising:
one or more processors and executable instructions accessible on a computer-readable medium that, when executed, configure the one or more processors to at least:
receive a query that includes one or more search terms, the query being transmitted from a device operated by a user that is searching for an item;
access an item vector that corresponds to a description of at least one published item listing;
generate a vector that corresponds to the query, the generating being based on a machine-learning model that projects the one or more search terms into a common vector space;
identify a distance in the common vector space between the vector that corresponds to the query and the item vector that corresponds to the description; and
determine a match between the query and the description of the at least one item listing based on the distance.

12. The system of claim 11, wherein the one or more processors are further configured to:
generate the item vector that corresponds to the description of the at least one published item listing, the generating being based on the machine-learning model; and
store the item vector in a database.

13. The system of claim 11, wherein the one or more processors are further configured to:
determine that the distance between the vector that corresponds to the query and the item vector is within a predetermined distance; and
determine the match based on the determining that the distance is within the predetermined distance.

14. The system of claim 11, wherein each of the one or more search terms does not match with any words in the description of the at least one item listing.

15. The system of claim 11, wherein the one or more processors are further configured to:
receive confirmation of a match between a further query and the description of the at least one item listing, the further query including one or more further search terms; and
train the machine-learning model based on the received confirmation of the match between the one or more further search terms and the description of the at least one item listing.

16. The system of claim 15, wherein the one or more processors are further configured to receive, from a history log database, user activity that indicates a purchase of an item described by the description of the at least one item listing after viewing search results of the further query.

17. The system of claim 11, wherein the one or more processors are further configured to:
extract alphanumeric characters from the one or more search terms and the description; and
project the vector that corresponds to the query in the common vector space based on the alphanumeric characters.

18. The system of claim 11, wherein the one or more processors are further configured to:
retrieve search results of the query based on the determined match; and
cause display of the search results of the query, the search results including an item listing of an item that fits the description of the at least one item listing.

19. The system of claim 11, wherein the common vector space includes further vectors that correspond to descriptions of further products.

20. A non-transitory machine-readable medium storing instructions that, when executed by one or more processors of a machine, cause the machine to perform operations comprising:
receiving a query that includes one or more search terms, the query being transmitted from a device operated by a user that is searching for an item;
accessing an item vector that corresponds to a description of at least one published item listing;
generating a vector that corresponds to the query, the generating being based on a machine-learning model that projects the one or more search terms into a common vector space;
identifying a distance in the common vector space between the vector that corresponds to the query and the item vector that corresponds to the description; and
determining a match between the query and the description of the at least one item listing based on the distance.
